(19) United States
(12) Patent Application Publication
(10) Pub. No.: US 2026/0034969 A1
(43) Pub. Date: Feb. 5, 2026

(54) METHOD FOR BRAKING A VEHICLE, EMERGENCY BRAKING SYSTEM AND VEHICLE

(71) Applicant: ZF CV SYSTEMS GLOBAL GMBH, Bern (CH)

(72) Inventors: Rashmita KHARE, Patna (IN); Rüdiger MEYER, Hannover (DE); Lennart CLAUSSEN, Hannover (DE)

(21) Appl. No.: 19/139,380

(22) PCT Filed: Nov. 23, 2023
(86) PCT No.: PCT/EP2023/082860

§ 371 Date: Jun. 16, 2025

(30) Foreign Application Priority Data
Dec. 19, 2022 (IN) 202211073453

(51) Int. Cl. B60T 8/1755; B60T 7/22; B60W 30/09

(52) U.S. Cl. CPC B60T 8/17558; B60T 7/22; B60W 30/09; B60T 2201/022

(57) ABSTRACT

A method for braking a vehicle detects an object in a surrounding of the vehicle. The method determines if a collision between the vehicle and the detected object is imminent, where the detected object is treated as a collision-relevant first target-object in case a collision is imminent. An emergency braking process is initiated if the object is treated as a collision-relevant first target-object, by initiating a warning to a driver of the vehicle, in a first warning phase, initiating a braking of the vehicle with a predetermined braking request. During the braking process, it is continuously determined if the first target-object is still collision-relevant, and, in case the first target-object becomes collision-irrelevant during carrying out the braking process the braking phase is aborted, where the braking process request is decreased in an additional ramp-out phase, while determining if a collision between the vehicle and the detected object is imminent.

### CROSS REFERENCE TO RELATED APPLICATIONS

This application is a U.S. National Phase application under 35 U.S.C. § 371 of International Application No. PCT/EP2023/082860, filed on Nov. 23, 2023, and claims benefit to Indian Patent Application No. IN 202211073453, filed on Dec. 19, 2022. The International Application was published in English on Jun. 27, 2024 as WO 2024/132361 A1 under PCT Article 21 (2).

### FIELD

The present disclosure relates to a method for braking a vehicle, in particular within an advanced emergency braking system (AEBS).

### BACKGROUND

In conventional emergency braking systems (AEBS-Advanced Emergency Braking System), a sensor-system senses the surrounding in front of the vehicle, and a control algorithm inside an AEBS-control-unit monitors if there is a chance of the vehicle colliding with any other vehicle on road. In case a target-object is present on the road, wherein a target-object is a collision-relevant object, i.e., a collision between the vehicle and this target-object is imminent or likely to occur, an emergency braking process is triggered. As part of the emergency braking process, the emergency braking system reacts in a phased approach: it starts with warning the driver (first warning phase), then applying limited or partial braking (haptic warning phase) to reduce the criticality of the situation and afterwards applies full braking (emergency braking phase). A minimum warning and limited braking time (warning threshold) is needed to be elapsed before the emergency braking system can request the full braking in the emergency braking phase. This phased approach is required to inform the driver of the vehicle about potential risk of collision (first warning phase) plus avoid risk of unjustified rear end collision with the following traffic (haptic warning phase). The phased approach is also mandatory by Homologation in some countries.

During this emergency braking process, if the (first) target-object or the vehicle does a lane change, the emergency braking process will abort as the (first) target-object is out of the path of the vehicle. In case, just after the lane change, there is a new second target-object present on road, that is also collision-relevant, a conventional emergency braking system triggers a second emergency braking process, which needs to again follow the phased approach: first warning, haptic warning with partial braking, and full braking, again taking into account the minimum warning and limited braking time (warning threshold), which is starting all over again. Due to this approach, it is difficult to avoid a collision on new emerging target-objects.

Emergency braking system known in the art are described in, e.g., DE 10 2007 060 862 B4, EP 2 595 135 A1, US2011178710 A1, wherein in these documents the phased approach as such is not adapted in dependence of existing target objects and it is not intended to change the target-object during emergency braking. It is rather intended to use information about the possibility to steer around a target-object in order to adapt the timing of the emergency braking process.

### SUMMARY

In an embodiment, the present disclosure provides a method for braking a vehicle, comprising the steps of detecting an object in a surrounding of the vehicle; determining, if a collision between the vehicle and the detected object is imminent or likely to occur, wherein the detected object is treated as a collision-relevant first target-object in case a collision is imminent or likely to occur; initiating or triggering an emergency braking process, if the object is treated as a collision-relevant first target-object, by successively: initiating a warning to a driver of the vehicle, in a first warning phase; initiating a partial braking of the vehicle with a predetermined, constant or continuously increasing partial braking request, in a haptic warning phase; and afterwards initiating a full braking of the vehicle with a predetermined emergency braking request, in an emergency braking phase. During the emergency braking process, it is continuously determined if the first target-object is still collision-relevant, and, in case the first target-object becomes collision-irrelevant during carrying out the emergency braking process, meaning that a collision between the vehicle and the first target-object is not imminent or not likely to occur any more, the haptic warning phase, if active, or the emergency braking phase, if active, is aborted, wherein the partial braking request, after abortion of the haptic warning phase (K2), or the emergency braking request, after abortion of the emergency braking phase, is decreased in an additional ramp-out phase. During the additional ramp-out phase, it is continuously determined if a collision between the vehicle and a detected object in the surrounding is imminent or likely to occur, wherein the detected object is treated as a collision-relevant second target-object in case a collision is imminent or likely to occur, wherein in case the object is treated as a collision-relevant second target-object the emergency braking process is resumed by initiating a braking of the vehicle with a braking request depending on: a collision-relevancy of the second target-object, and/or a warning time already elapsed during the emergency braking process and/or a predetermined warning threshold.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 depicts a schematic view of a vehicle comprising an emergency braking system;

FIG. 2A depicts an AEBS-cascade of a conventional emergency braking system;

FIGS. 2B, 2C and 2D depict embodiments of an AEBS-cascade according to the one or more embodiments of the present disclosure;

FIGS. 3A and 3B depict traffic situations showing the changing relevance of target-objects, according to one or more embodiments of the present disclosure; and

FIG. 4 depicts a flowchart of the method, according to one or more embodiments of the present disclosure.

### DETAILED DESCRIPTION

In accordance with an embodiment, the present disclosure provides a method for braking a vehicle, in particular within an advanced emergency braking system (AEBS), comprising the steps of
detecting an object in a surrounding of the vehicle, e.g., using a sensor system and/or an object recognition unit;
   determining, if a collision between said vehicle and said detected object is imminent or likely to occur, wherein said detected object is treated as a collision-relevant first target-object in case a collision is imminent or likely to occur;
initiating or triggering an emergency braking process, if said object is treated as a collision-relevant first target-object, by successively or in this order
initiating a visual or acoustic warning to the driver of the vehicle, in a first warning phase;
initiating a partial braking of the vehicle with a predetermined, constant or continuously increasing partial braking request, in a haptic warning phase; and afterwards
initiating a full braking of the vehicle with a predetermined emergency braking request, in an emergency braking phase;
   wherein, during the emergency braking process, it is continuously determined, e.g., based on the sensor-signals of the sensor system, if the first target-object is still collision-relevant, and, in case the first target-object becomes collision-irrelevant during carrying out the emergency braking process, meaning that a collision between said vehicle and said first target-object is not imminent or not likely to occur any more, the haptic warning phase, if active, or the emergency braking phase, if active, is aborted, and
the partial braking request, after abortion of the haptic warning phase, if was active, or
the emergency braking request, after abortion of the emergency braking phase, if was active, is continuously (not abruptly) decreased to a ramp-out braking request, e.g., −1 m/s², in an additional ramp-out phase, such that the ramp-out braking request is reached, in particular, on or after a predetermined ramp-out time has elapsed after initiation of the ramp-out phase, and/or by taking into account a predetermined braking gradient;
   wherein, during said ramp-out phase, it is continuously determined if a collision between said vehicle and a detected object in the surrounding is imminent or likely to occur, wherein said detected object is treated as a collision-relevant second target-object in case a collision is imminent or likely to occur,
   wherein in case said object is treated as a collision-relevant second target-object the emergency braking process is resumed by initiating a braking of the vehicle with a braking request depending on
a collision-relevancy of said second target-object, and/or
a warning time already elapsed during the emergency braking process and/or
a predetermined warning threshold.

Embodiments of the present disclosure also relate to an emergency braking system, configured to carry out the method according to the disclosure, and a vehicle, comprising the emergency braking system.

Advantageously, by using this method, a faster and stronger reaction on the second target-object can be achieved, enhancing the performance of the advanced emergency braking system. In particular, this is accomplished because the warning time is not reset after abortion of the haptic warning phase, if active, or the emergency warning phase, if active, once the first target-object becomes collision-irrelevant and the ramp-out phase is triggered. In this context, that the warning time is not reset after abortion of the respective phase means that counting of the warning time continues during the following ramp-out phase or stops/pauses during the following ramp-out phase and continues again on detection of the collision-relevant second target-object.

As during the ramp-out phase, the vehicle is still decelerating with braking lights activated, the legally required warning of the following traffic is still ongoing, although there is no target-object present at that time. Consequently, on a subsequent occurrence of a collision-relevant second target-object during this ramp-out phase, the warning time is not beginning to count from zero allowing a faster reaction on the second target-object. Preferably, if no additional second target-object emerges within the ramp-out phase, the emergency braking process is just ending or aborted, e.g., once the ramp-out braking request is reached, e.g., after the predetermined ramp-out time has elapsed.

In a preferred embodiment, in case said object is treated as a collision-relevant second target-object the emergency braking process is resumed, independent or dependent on the collision-relevancy of said second target-object,
in the haptic warning phase by initiating a partial braking of the vehicle with the predetermined, constant or continuously increasing partial braking request, or
in the emergency braking phase by initiating a full braking of the vehicle with the predetermined emergency braking request, depending on the warning time already elapsed during the emergency braking process and/or the predetermined warning threshold. Consequently, the respective phase, that was aborted before, is resumed.

Otherwise, in case said object is treated as a collision-relevant second target-object the emergency braking process is resumed by initiating a braking with a braking request, which is stronger the higher the collision-relevancy of said second target-object and which is the weaker the lower the collision-relevancy of said second target-object. Thus, a braking request is set that is justified by the emergency level or the collision relevance in the respective situation, in order to provide high comfort for the driver.

In a preferred embodiment, the warning time is counted during
the first warning phase, and
the haptic warning phase and/or during a partial braking of the vehicle with the predetermined, constant or continuously increasing partial braking request is initiated, wherein the emergency braking phase and/or a full braking of the vehicle with a predetermined emergency braking request is initiated only after the warning time exceeds a predetermined warning-threshold. This is to fulfill the legal requirements, wherein the counting of the warning time is expanded over the subsequent emergency braking events or the subsequent occurrences of the target-objects in order to enhance the performance of the AEBS in a way describe above (counting continues during the ramp-out phase or stops/pauses during the ramp-out phase).

In a preferred embodiment, the additional ramp-out phase is triggered just in case objects are detected in the surrounding of the vehicle, that may in principle be qualified as collision-relevant target-objects, e.g., foreign vehicles on the same lane as the vehicle and/or on neighboring lanes. Thus, it can further be checked if the ramp-out phase is really needed. Consequently, in a preferred embodiment, the emergency braking process is aborted, if no objects are detected in the surrounding of the vehicle, that may in principle be qualified as collision-relevant target-objects. Thus, the ramp-out phase can be omitted, limiting any emergency braking action to a time frame, that is really needed.

In alternative embodiments, taking into account that the first target-object might become collision-relevant again, the ramp-out phase is always triggered after aborting the respective phases of the cascade.

In a preferred embodiment, it is determined that the first target-object becomes collision-irrelevant during carrying out the emergency braking process, if the vehicle and/or the first target-object is changing lanes. This is a preferred driving situation, in which a change of target-objects might occur, wherein the emergency braking system cannot always fully consider what will happen in the future, so the method according to the disclosure can be used to optimize the transition of target-objects during such a lane changing event.

In a preferred embodiment, the warning-threshold is between 1.4s and 1.5s. This gives enough time to warn the driver of the vehicle, e.g., for manual overriding, as well as warn the following traffic, in order to adequately react to the emergency situation.

In a preferred embodiment, the predetermined partial braking request corresponds to a vehicle acceleration of about −3 m/s² or above. This is an advantageous value to activate braking lights and in addition warn the driver and the following traffic, with just a minor braking request.

In a preferred embodiment, the predetermined emergency braking request for full braking corresponds to a vehicle acceleration of about −4 m/s² or below, in particular −6 m/s² or below. This is an advantageous value in order to brake the vehicle as fast as possible in an emergency event.

In a preferred embodiment, the ramp-out braking request corresponds to a vehicle acceleration of −1 m/s², at a minimum, and/or the predetermined ramp-out time is set to 0.5s, at a minimum. Within these values, an extended ramp-out phase can be provided in order to still leave the braking lights activated for a certain time and providing a sufficient amount of time to detect another second target-object, without expanding the ramp-out phase too much after the first target-object became collision-irrelevant. The values for the ramp-out braking request and the ramp-out time are exemplary values that might be chosen or adapted based on a preferred trade-off between the performance of the AEBS-system to detect new target objects during the ramp-out phase and to keep the ramp-out phase minimum to avoid extending unintended braking in case of false events. Therefore, these values might be parametrized based on the configuration of the AEBS-system, e.g., the characteristics of the sensor-system, or the like.

In a preferred embodiment, the predetermined ramp-out braking request is set in such a way, that braking lights of the vehicle are still activated during ramp-out phase. This allows for expanding the warning time over to the occurrence of a second target-object, as already described.

Additional features of the present disclosure will become apparent to those skilled in the art upon consideration of the embodiments shown in the drawings.

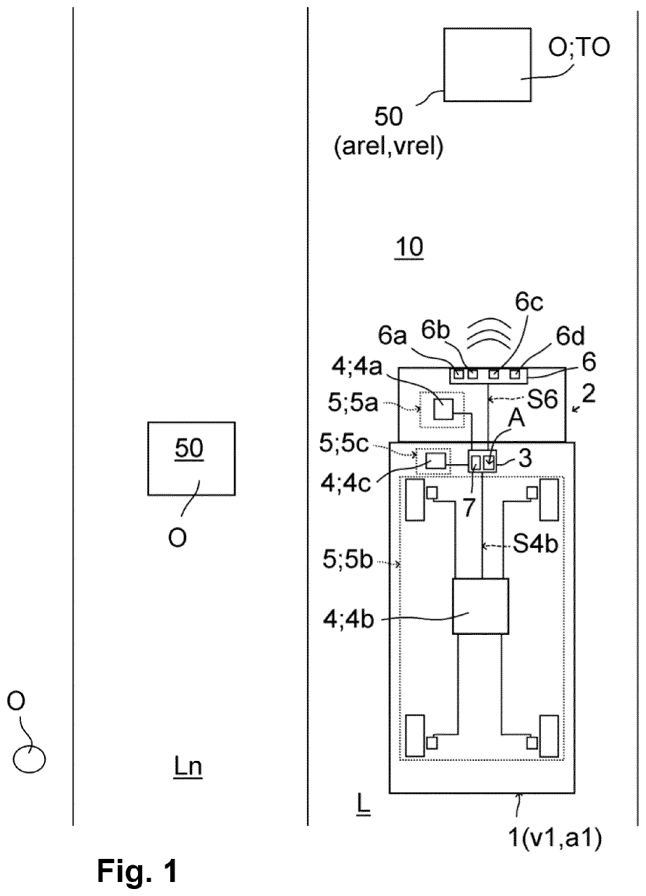

FIG. 1 schematically shows a vehicle 1 having an emergency braking system 2 (AEBS—Advanced Emergency Braking System) controlled by an AEBS-control unit 3, for preventing collisions or mitigating their consequences. The AEBS-control unit 3 is electrically connected to actuator controllers 4 controlling actuators 5 of the vehicle 1, e.g., a steering controller 4a controlling a steering system 5a of the vehicle 1, a braking controller 4b controlling a braking system 5b of the vehicle 1 and a drive controller 4c controlling a drive system 5c (including engine and transmission) of the vehicle 1. The AEBS-control unit 3 is configured to generate and provide control signals to the respective actuator controllers 4 for assisting the driver based on information provided by a sensor system 6, e.g., comprising a camera 6a and/or radar sensors 6b and/or UV-sensors 6c and/or LIDAR-Sensors 6d or the like. In addition, the AEBS-control unit 3 is configured to receive and process signals from the respective actuator controllers 4 for assisting the driver.

The sensor system 6 is configured to capture a surrounding 10 of the vehicle 1 and provide sensor-signals S6 characterizing the surrounding 10. An object recognition unit 7, e.g., as an integral part of AEBS-control-unit 3 or the sensor system 6 or as an external unit, is able to identify objects O, e.g., other foreign vehicles 50, in the surrounding 10 by processing the sensor-signals S6. The AEBS-control-unit 3 is then able to assist the driver based on the occurrence of collision-relevant target-objects TO, such as foreign vehicles 50 on the same lane L or on neighboring lanes Ln, in particular by initiating or triggering an emergency braking process P, by outputting a certain braking request zReq.

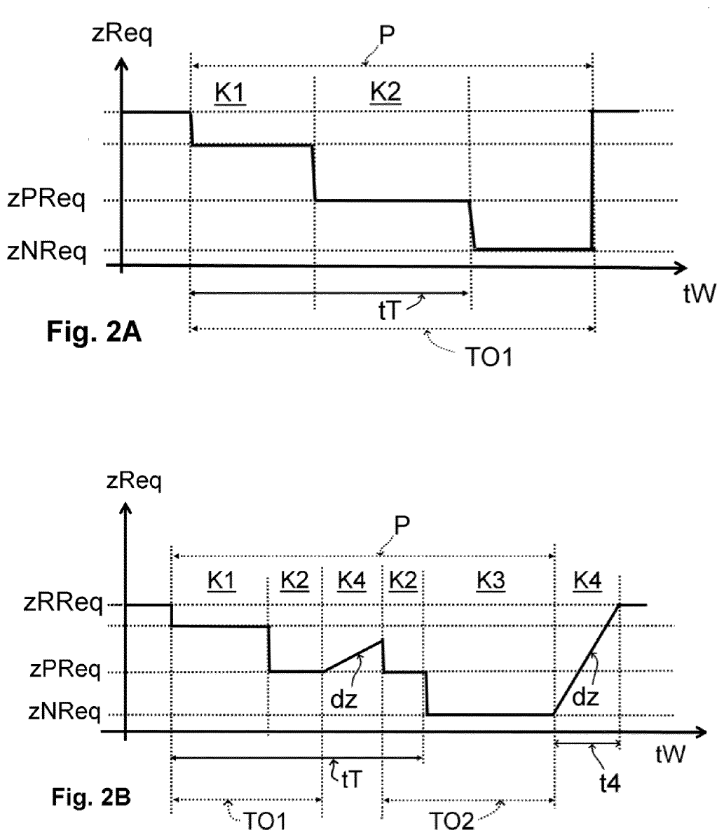

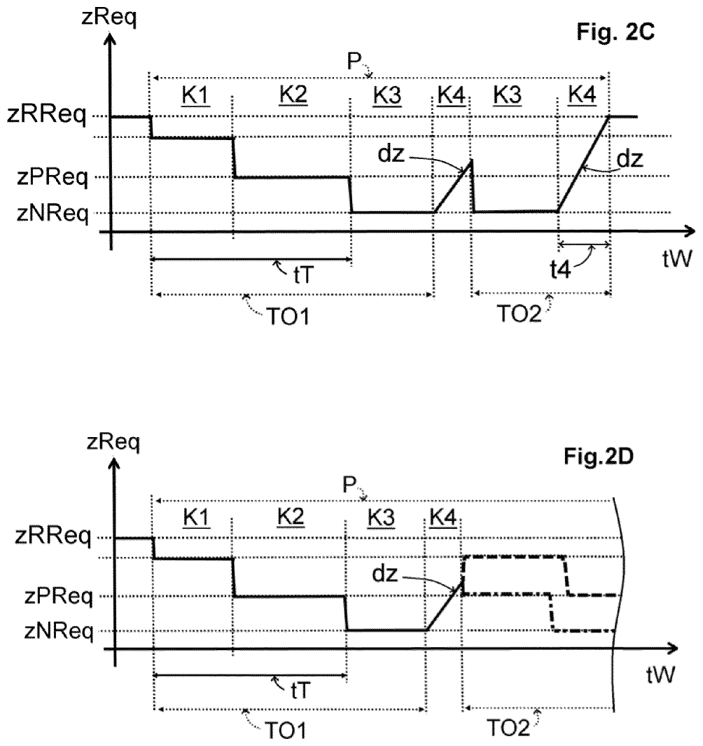

In order to determine if an emergency braking process P has to be triggered, the AEBS-control-unit 3 is able to assess, via an AEBS algorithm A, e.g., based on a vehicle-acceleration al or a vehicle-speed vl or a relative speed vrel or relative acceleration between the vehicle 1 and a detected object O, if a collision is imminent or likely to occur. In case a collision is imminent or likely to occur, the respective object O subsequently becomes a target-object TO and the AEBS-control-unit 3 initiates an emergency braking process P, considering a so called AEBS-cascade K, depicted in FIG. 2A, for assisting the driver, in particular, in braking the vehicle 1 as fast as possible.

Said AEBS-cascade K includes a first warning phase K1, triggering a visual (display) and/or an acoustic (warning signal) warning, a haptic warning phase K2, triggering a partial braking of the vehicle 1 with a predetermined, constant or continuously increasing partial braking request zPReq, e.g., ramping the vehicle acceleration al down to −3 m/s², and an emergency braking phase K3, in particular, in dependence of a predetermined emergency braking request zNReq, e.g., a vehicle acceleration of −4 m/s², in particular down to −6 m/s². This AEBS cascade K advantageously allows manual overriding of the activation of an emergency braking by the driver of the vehicle 1 during the first warning phase K1 or the haptic warning phase K2, in case of false detection, and ensures a reaction time for the following traffic, during partially braking the vehicle 1 with activated braking lights at least during haptic warning phase K2. In certain embodiments, during the first warning phase K1, the brakes can already be prefilled with pressurized fluid, e.g., gas or liquid, for reducing the dead time of the brakes by reducing the air space between the brake pads and the disc/drum of the brake, without actually causing an additional speed reduction, and in addition for activating the braking lights already during the first warning phase K1.

As per functional safety, a warning time tW (visual/acoustic K1, haptic K2) before the emergency braking process P can enter the emergency braking phase K3 has to exceed a predetermined warning-threshold tT, wherein a warning threshold tT of 1.4s to 1.5s is set by way of example. If the braking lights are already activated during the first warning phase K1 (by prefilling of the brakes), the warning time tW counts from the beginning of the emergency braking process P, while if the braking lights are not activated until the haptic warning phase K2 begins (e.g., no prefilling of the brakes), the warning time tW counts from the beginning of the haptic warning phase K2 to ensure the rear vehicle safety.

As soon as the emergency braking process P enters the haptic warning phase K2 of said AEBS-cascade K the AEBS-control-unit 3 outputs the predetermined partial braking request zPReq via the braking control signal S4b to the braking actuator controller 4b for actuation of the respective brakes of the braking system 5b in accordance with the partial braking request zPReq. To ensure that the partial braking request zPReq can be realized as soon as possible in the haptic warning phase K2, the brakes can already be prefilled with pressurized fluid in the first warning phase K1 as stated above. As soon as the emergency braking process P enters the emergency braking phase K3, the AEBS-control-unit 3 outputs the predetermined emergency braking request zNReq via the braking control signal S4b to the braking actuator controller 4b for actuation of the respective brakes of the braking system 5b in accordance with the emergency braking request zNReq.

In conventional emergency braking systems, in case a detected first target-object TO1 is not collision relevant any more, e.g., because the vehicle 1 or the respective first target-object TO1 is changing lanes L, Ln or is accelerating/decelerating, the emergency braking process P or AEBS cascade K is aborted in the respective phase K1, K2, K3, abruptly decreasing the braking request zReq outputted via the braking control signal S4b. After such an abortion of the emergency braking process P and on a subsequent detection of a new target-object TO, with which a collision is imminent or likely, in conventional emergency braking systems, the AEBS-control-unit 3 is initiating a new emergency braking process P, again considering the above mentioned AEBS cascade K, wherein the warning time tW (visual/acoustic K1, haptic K2) is starting again to count from zero within this new emergency braking process P.

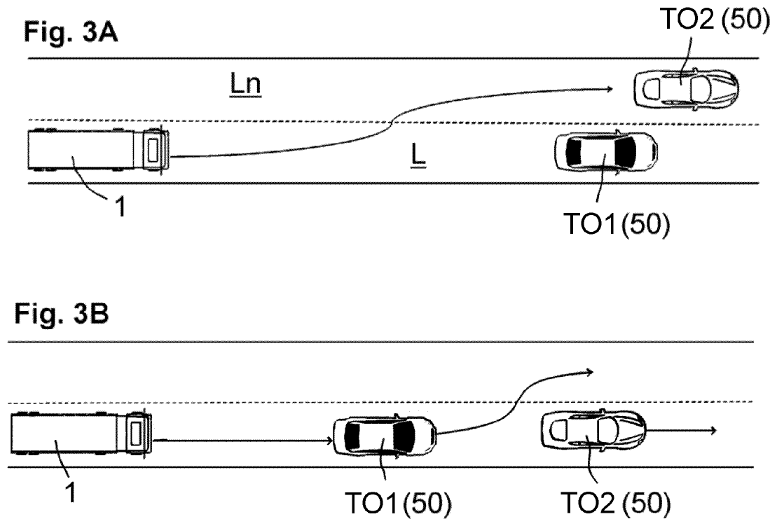

In the situation described above, a new collision relevant target-object TO may be the first target-object TO1 again, e.g., after deciding to cancel or undo the lane changing process or decelerating again, or a second target-object TO2 emerging before the vehicle 1. The second target-object TO2 may emerge before the vehicle 1 after the first target-object TO1 moved to the neighboring lane Ln (see FIG. 3A) or after the vehicle 1 itself has moved to the neighboring lane Ln (see FIG. 3B) already containing the second target-object TO2.

According to embodiments of the present disclosure, the emergency braking process P is adapted in its AEBS-cascade K as follows in order to optimize the transition in case of a successive occurrence of two different collision-relevant target-objects TO; TO1, TO2:

Once it is determined, during the haptic warning phase K2, as depicted in the illustrative embodiment of FIG. 2B, or during the emergency braking phase K3, as depicted in the illustrative embodiment of FIG. 2C or FIG. 2D, that the initial or first target-object TO1 is not collision-relevant any more, a ramp-out phase K4 is added to the AEBS-cascade K, intended for continuously, not abruptly ramping down the braking request zReq. Therefore, during the ramp-out phase K4 the partial braking request zPReq (if haptic warning phase K2 is active, FIG. 2B) or the emergency braking request zNReq (if emergency braking phase K3 is active, s. FIG. 2C, 2D) is decreased to a predetermined ramp-out braking request zRReq, e.g., to zRReq=−1 m/s², such that the braking request zReq during ramp-out phase K4 is still significant enough to continuously activate the braking lights for warning the following traffic in the surrounding 10.

Therefore, the AEBS-control-unit 3 outputs the predetermined ramp-out braking request zRReq via the braking control signal S4b to the braking actuator controller 4b for actuation of the respective brakes of the braking system 5b in such a way that the predetermined ramp-out braking request zRReq, e.g., −1 m/s², is reached within a predetermined ramp-out time t4 of, e.g., 0.5s. Thus, the partial braking request zPReq or the emergency braking request zNReq is decreased to the predetermined ramp-out braking request zRReq within this predetermined ramp-out time t4, leading to a certain braking gradient dz. In other embodiments, a braking gradient dz in combination with a ramp-out time t4 may be predefined or predetermined by the AEBS-control-unit 3 in such a way that a ramp-out braking request zRReq of approx . . . 1 m/s² is automatically reached as soon as the ramp-out time t4, e.g., 0.5s, has elapsed.

The values for the ramp-out braking request zRReq and the ramp-out time t4 are exemplary values that might be chosen or adapted based on a preferred trade-off between the performance of the AEBS-system to detect new target objects TO during the ramp-out phase K4, as described hereinafter, and to keep the ramp-out phase K4 minimum to avoid extending unintended braking in case of false events.

Consequently, during the ramp-out phase K4, the warning time tW is not reset to zero as the ramp-out braking request zRReq within the still ongoing emergency braking process P is high enough to ensure perception in the surrounding 10 and/or of the following traffic. In this context, that the warning time tW is not reset to zero after abortion of the respective phase K2, K3 means that counting of the warning time tW continues during the ramp-out phase K4 or stops or pauses during the ramp-out phase K4 and continues on detection of new target-object TO as described hereinafter.

In preferred embodiments of the disclosure, the ramp-out phase K4 is just added, if other objects O can be identified in the surrounding 10, e.g., by the object recognition unit 7, which may in principle be qualified as collision-relevant target-objects TO (at present or in the future), e.g., foreign vehicles 50 on the same lane L and/or a neighboring lane Ln. If no such objects O can be identified, the emergency braking process P may end immediately as the initial or first target-object TO1 becomes collision-irrelevant. However, in an alternative embodiment, the ramp-out phase K4 can be added regardless of whether other objects O can be identified in the surrounding 10 at the time the first target object TO1 becomes collision-irrelevant.

If any new collision-relevant target-object TO, e.g., a second target-object TO2 as described above, emerges before the vehicle 1 during the added ramp-out phase K4, the AEBS-control-unit 3 increases the braking request zReq again, taking into account said predetermined warning threshold tT as follows:

If, according to the illustrative embodiment of FIG. 2B, the second target-object TO2 emerges before the predetermined warning threshold tT has elapsed, wherein the warning time tW counts from the beginning of the still ongoing emergency braking process P (either continuing or pausing during ramp-out phase K4), the AEBS-control-unit 3 again outputs the predetermined partial braking request zPReq in order to resume the haptic warning phase K2, that was aborted before. Once the warning time tW exceeds the predetermined warning threshold tT the AEBS-control-unit 3 outputs the predetermined emergency braking request zNReq, in order to transition from the resumed haptic warning phase K2 into the emergency braking phase K3, as depicted in FIG. 2B. In this way, the warning time tW is not reset after the first target-object TO1 has become collision-irrelevant, but is rather expanded into the period the second target-object TO2 becomes collision-relevant, due to the ramp-out phase K4, still ensuring a reaction time for the following traffic when braking the vehicle 1 with a continuous activation of the braking lights.

If, according to the illustrative embodiment of FIG. 2C, the second target-object TO2 emerges after the predetermined warning threshold tT has elapsed, wherein the warning time tW counts from the beginning of the still ongoing emergency braking process P (either continuing or pausing during ramp-out phase K4), the AEBS-control-unit 3 again outputs the predetermined emergency braking request zNReq in order to resume the emergency braking phase K3, that was aborted before. In this way, the warning time tW is not reset after the first target-object TO1 has become collision-irrelevant but is rather expanded into the period the second target-object TO2 becomes collision-relevant, due to the ramp-out phase K4, still ensuring a reaction time for the following traffic when braking the vehicle 1 with a continuous activation of the braking lights.

If, according to the illustrative embodiment of FIG. 2D, the second target-object TO2 emerges after the predetermined warning threshold tT has elapsed, wherein the warning time tW counts from the beginning of the still ongoing emergency braking process P (either continuing or pausing during ramp-out phase K4), the AEBS-control-unit 3 again outputs a braking request zReq that in this case is dependent on a collision-relevancy R of the second target-object TO2. Thus, the emergency braking phase K3, that was aborted before, is not resumed, if the collision relevancy R is not that high to justify the initiation of the predetermined emergency braking request zNReq again. Thereby, the collision-relevancy R of the second target-object TO2 is determined by common methods, in particular, including the analysis of the relative motion (arel, vrel) of the second target-object TO2 in relation to the vehicle 1.

Consequently, as depicted by the dashed or dotdashed lines in FIG. 2D, the higher/lower the collision-relevancy R of the second target-object TO2 the stronger/weaker braking request zReq is set, e.g., the predetermined partial braking request zPReq (dotdashed) is set at moderate collision-relevancy R or a weak braking request zReq (dashed), at least leaving the brakes prefilled with pressurized fluid is set at low collision relevancy R. Further, on high collision-relevancy R the predetermined emergency braking request zNReq can be set, as described in the context of FIG. 2C.

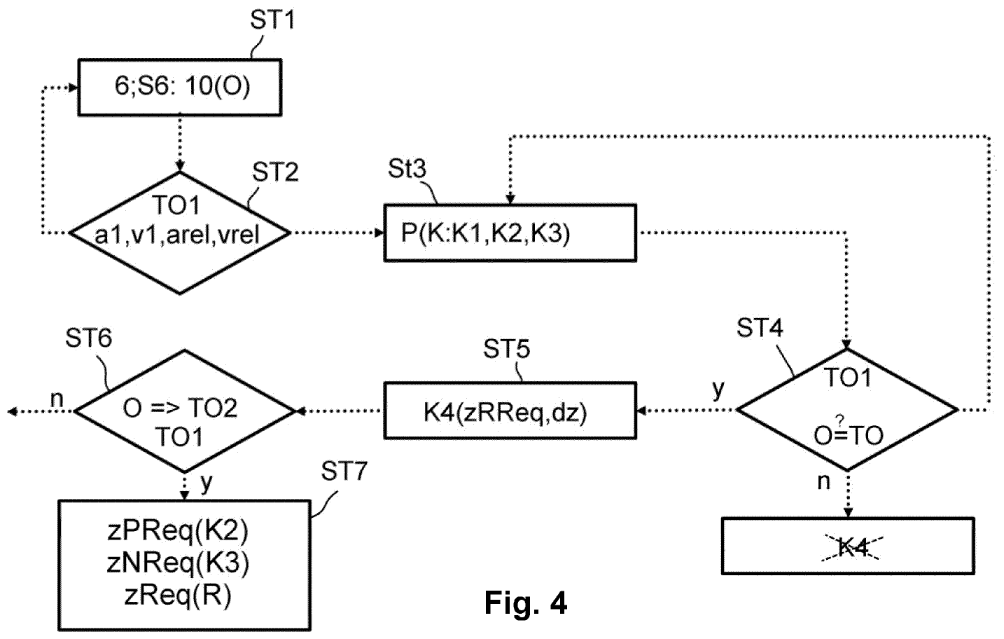

An illustrative embodiment of the method according to the disclosure is shown in the flowchart of FIG. 4, wherein in a first step ST1, the surrounding 10 is sensed by the sensor-system 6, wherein after detecting a collision-relevant first target-object TO1 in a second step ST2, e.g., by the object recognition unit 7, the emergency braking process P is started or continued in a third step ST3 by processing the individual phases K1, K2, K3 of the AEBS-cascade K, as described above. If, in a fourth step ST4, it is determined that the first target-object TO1 is not collision-relevant any more (collision-irrelevant), and (optionally) further objects O, that may qualify as collision-relevant target-objects TO, are present in the surrounding 10, the ramp-out phase K4 is initiated in a fifth step ST5, ramping down the braking request zReq as described above and either continuing or pausing the counting of the warning time tW. In particular, if no further objects O are detected in the surrounding 10 of the vehicle 1 at the time the first target object TO1 becomes collision-irrelevant, the ramp-out phase K4 might (optionally) be omitted. In case the first target-object TO1 is still collision-relevant, which is determined continuously, the emergency braking process P is continued using the phased approach.

If, in a sixth step ST6, an object O detected in the surrounding 10 is classified as a collision-relevant second target-object TO2 during the ramp-out phase K4 (i.e., before ramp-out time t4 has elapsed and/or ramp-out braking request zRReq is reached), or the first target-object TO1 becomes collision-relevant again during the ramp-out phase K4 (i.e., before ramp-out time t4 has elapsed and/or ramp-out braking request zRReq is reached),
the partial braking request zPReq is demanded, in case the predetermined warning threshold tT has not elapsed yet, or
the emergency braking request zNReq is demanded, in case the predetermined warning threshold tT has elapsed already
   in a seventh step ST7. As described in respect to FIG. 2D, the braking request zReq after ramping out can in addition be set in dependence of the collision-relevancy R of the second target-object TO2 or the first target object TO1 becoming collision-relevant again.

If, during ramp-out phase K4, no collision relevant target-object TO is detected in the sixth step ST6 the emergency braking process P ends, e.g., with unactuated brakes or no additional brake requests zReq, after the ramp-out phase K4 is completed, i.e., the predetermined ramp-out time t4 has elapsed and/or the predetermined ramp-out braking request zRReq is reached.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

REFERENCE SIGNS (AS PART OF THE DESCRIPTION)

| | |
|---|---|
| 1 | vehicle |
| 2 | emergency braking system |
| 3 | AEBS-control-unit |
| 4 | actuator controllers |
| 4a | steering controller |
| 4b | braking controller |
| 4c | drive controller |
| 5 | actuators |
| 5a | steering system |
| 5b | braking system |
| 5c | driving system |
| 6 | sensor-system |
| 6a | camera |
| 6b | radar sensor |
| 6c | UV-sensor |
| 6d | LIDAR-sensor |
| 7 | object recognition unit |
| 10 | surrounding |
| 50 | foreign vehicle |
| a1 | vehicle-acceleration |
| arel | relative acceleration |
| A | AEBS algorithm |
| dz | braking gradient |
| K | AEBS-cascade |
| K1 | first warning phase |
| K2 | haptic warning phase |
| K3 | emergency braking phase |
| K4 | ramp-out phase |
| L | lane |
| Ln | neighboring lane |
| O | object |
| P | emergency braking process |
| R | collision-relevancy |
| S6 | sensor-signal |
| t4 | ramp-out time |
| TO | target object |
| TO1 | first target object |
| TO2 | second target object |
| tT | warning-threshold |
| tW | warning time |
| v1 | vehicle speed |
| vrel | relative speed |
| zReq | braking request |
| zNReq | emergency braking request |
| zPReq | partial braking request |
| zRReq | ramp-out braking request |
| ST1, ST2, ST3, ST4, | steps of the method |
| ST5, ST6, ST7 | |

1. A method for braking a vehicle, comprising the steps of
detecting an object in a surrounding of the vehicle:
determining, if a collision between the vehicle and the detected object is imminent or likely to occur, wherein the detected object is treated as a collision-relevant first target-object in case a collision is imminent or likely to occur:
initiating or triggering an emergency braking process, if the object is treated as a collision-relevant first target-object, by successively
initiating a warning to a driver of the vehicle, in a first warning phase:
initiating a partial braking of vehicle with a predetermined, constant or continuously increasing partial braking request, in a haptic warning phase; and afterwards
initiating a full braking of the vehicle with a predetermined emergency braking request, in an emergency braking phase:
wherein, during the emergency braking process, it is continuously determined if the first target-object is still collision-relevant, and, in case the first target-object becomes collision-irrelevant during carrying out the emergency braking process, meaning that a collision between the vehicle and the first target-object is not imminent or not likely to occur any more, the haptic warning phase, if active, or the emergency braking phase, if active, is aborted, wherein
the partial braking request, after abortion of the haptic warning phase, or
the emergency braking request, after abortion of the emergency braking phase,
is decreased in an additional ramp-out phase;
wherein, during the additional ramp-out phase, it is continuously determined if a collision between the vehicle and a detected object in the surrounding is imminent or likely to occur, wherein the detected object is treated as a collision-relevant second target-object in case a collision is imminent or likely to occur,
wherein in case the object is treated as a collision-relevant second target-object the emergency braking process is resumed by initiating a braking of the vehicle with a braking request depending on
a collision-relevancy of the second target-object, and/or
a warning time already elapsed during the emergency braking process and/or
a predetermined warning threshold.

2. The method according to claim 1, wherein in case the object is treated as a collision-relevant second target-object the emergency braking process is resumed, independent or dependent on the collision-relevancy of the second target-object,
in the haptic warning phase by initiating a partial braking of the vehicle with the predetermined, constant or continuously increasing partial braking request, or
in the emergency braking phase by initiating a full braking of the vehicle with the predetermined emergency braking request,
depending on the warning time already elapsed during the emergency braking process and/or the predetermined warning threshold.

3. The method according to claim 1, wherein in case the object is treated as a collision-relevant second target-object the emergency braking process is resumed by initiating a braking with a braking request, which is stronger than a higher the collision-relevancy of the second target-object and which is weaker than a lower the collision-relevancy of the second target-object.

4. The method according to claim 1, wherein, during ramp-out-phase, the partial braking request or the emergency braking request is decreased to a ramp-out braking request in dependence of a predetermined ramp-out time and/or a predetermined braking gradient.

5. The method according to claim 4, wherein the ramp-out braking request corresponds to a vehicle acceleration of −1 m/s², at a minimum, and/or the predetermined ramp-out time is set to 0.5s, at a minimum.

6. The method according to claim 4, wherein the ramp-out braking request is set in such a way, that braking lights of the vehicle are continuously activated during ramp-out phase.

7. The method according to claim 4, wherein the additional ramp-out phase is completed once the ramp-out braking request is reached.

8. The method according to claim 1, wherein the warning time is counted during
the first warning phase, and
the haptic warning phase and/or during a partial braking of the vehicle with the predetermined, constant or continuously increasing partial braking request is initiated, wherein the emergency braking phase and/or a full braking of the vehicle with a predetermined emergency braking request is initiated only after the warning time exceeds a predetermined warning-threshold.

9. The method according to claim 8, wherein the warning time is not reset after abortion of the haptic warning phase, if was active, or the emergency braking phase, if was active, once the first target-object becomes collision-irrelevant and the additional ramp-out phase is triggered.

10. The method according to claim 9, wherein the counting of the warning time is continued during ramp-out phase or is paused during ramp-out phase.

11. The method according to claim 1, wherein the additional ramp-out phase is triggered just in case objects are detected in the surrounding of the vehicle, that may in principle be qualified as collision-relevant target-objects, e.g., foreign vehicles on a same lane as the vehicle and/or on neighboring lanes.

12. The method according to claim 11, wherein the emergency braking process is aborted, if no objects are detected in the surrounding of the vehicle, that may in principle be qualified as collision-relevant target-objects.

13. The method according to claim 1, wherein the additional ramp-out phase is triggered regardless of whether objects are detected in the surrounding of the vehicle, that may in principle be qualified as collision-relevant target-objects, e.g., foreign vehicles on the same lane as the vehicle and/or on neighboring lanes.

14. The method according to claim 1, wherein it is determined that the first target-object becomes collision-irrelevant during carrying out the emergency braking process, if the vehicle and/or the first target-object is changing lanes.

15. The method according to claim 1, wherein the predetermined warning-threshold is, in particular, between 1.4s and 1.5s.

16. The method according to claim 1, wherein the predetermined partial braking request corresponds to a vehicle acceleration of −3 m/s² or above.

17. The method according to claim 1, wherein the predetermined emergency braking request for full braking corresponds to a vehicle acceleration of −4 m/s² or below, in particular −6 m/s².

18. The method according to claim 1, wherein the emergency braking process is aborted after the additional ramp-out phase is completed, if it is determined, that a collision between the vehicle and a detected object in the surrounding is not imminent or is not likely to occur, and/or no object is treated as a second target-object.

19. An emergency braking system for a vehicle, in particular for carrying out the method, according to claim 1, comprising:
a sensor system configured to capture a surrounding of the vehicle and provide sensor-signals comprising the surrounding,
an object recognition unit configured to identify and detect objects in the surrounding by processing sensor-signals,
an AEBS-control-unit having an AEBS-algorithm for determining, if a collision between the vehicle and the detected object is imminent or likely to occur, wherein the detected object is treated as a collision-relevant first target-object in case a collision is imminent or likely to occur:
wherein the AEBS-control-unit or the AEBS-algorithm is further configured to:
initiate or trigger an emergency braking process, if said the detected object is treated as a collision-relevant first target-object, by successively
initiating a warning to a driver of the vehicle, in a first warning phase;
initiating a partial braking of the vehicle with a predetermined, constant or continuously increasing partial braking request, in a haptic warning phase; and afterwards
initiating a full braking of the vehicle with a predetermined emergency braking request, in an emergency braking phase;
wherein the AEBS-control-unit or the AEBS-algorithm is further configured
to continuously determine, during the emergency braking process, if the first target-object is still collision-relevant, and
to abort the haptic warning phase, if active, or the emergency braking phase, if active, in case the first target-object becomes collision-irrelevant during carrying out the emergency braking process, meaning that a collision between the vehicle and the first target-object is not imminent or not likely to occur any more, and to decrease
the partial braking request, after abortion of the haptic warning phase, or
the emergency braking request, after abortion of the emergency braking phase, in an additional ramp-out phase;
wherein the AEBS-control-unit or the AEBS-algorithm is further configured to continuously determine, during the additional ramp-out phase, if a collision between the vehicle and a detected object in the surrounding is imminent or likely to occur, wherein the detected object is treated as a collision-relevant second target-object in case a collision is imminent or likely to occur,
wherein in case said the detected object is treated as a collision-relevant second target-object, the AEBS-control-unit or the AEBS-algorithm is configured to resume the emergency braking process by initiating a braking of the vehicle with a braking request depending on
a collision-relevancy of the second target-object, and/or
a warning time already elapsed during the emergency braking process and/or
a predetermined warning threshold.

20. A vehicle, comprising the emergency braking system according to claim 19.
